(19) United States
(12) Patent Application Publication
(10) Pub. No.: US 2011/0083578 A1
(43) Pub. Date: Apr. 14, 2011

(54) BATTERY-POWERED RAIL VEHICLE

(75) Inventor: Syed Reza Ahmed SAMI, Irma, SC (US)

(73) Assignee: HARSCO CORPORATION, Camp Hill, PA (US)

(21) Appl. No.: 12/899,905

(22) Filed: Oct. 7, 2010

Related U.S. Application Data
(60) Provisional application No. 61/250,906, filed on Oct. 13, 2009.

(51) Int. Cl. B61C 3/00; B60L 5/38; H02P 3/14; H02J 7/32; B24B 27/00

(52) U.S. Cl. 105/50; 246/167 R; 191/49; 318/376; 320/138; 451/347

(57) ABSTRACT

A rail consist having at least one propulsion car having traction motors and at least one working car having working motors. Energy storage units are provided on the consist to provide power to the traction motors and the working motors. The energy storage units provide sufficient power for work mode, travel speeds and curve characteristics of the consist. The use of the energy storage units provides safety, environmental and operational benefits.

### FIELD OF THE INVENTION

The present invention is directed to a battery-powered rail vehicle which can be charged from various sources and which can be used where diesel fumes would endanger the environment or workers and/or when a diesel powered vehicle is not desired.

### BACKGROUND OF THE INVENTION

Conventional railroad locomotives and maintenance vehicles are typically powered by diesel-electric systems or by diesel-hydraulic systems. It is known that a hybrid locomotive or a hybrid locomotive/tender car combination can be used to capture and store energy that is otherwise wasted by incorporating an energy storage system (battery pack, capacitor bank, flywheel assemblies or combinations of these systems). The energy storage system may be charged by an on-board engine, by another hybrid or conventional locomotive in the consist, by a regenerative braking system or by an external source. The stored energy may be used to power the traction motors of the energy storage car or the traction motors of other operative members of the consist.

In many areas where rail use is widespread, especially large urban settings, there are special requirements for emissions and noise control which are becoming more and more stringent. Many rail vehicles typically make many starts and stops and often involve significant idling time. While conventional diesel locomotives are achieving higher emissions standards and fuel economy, there are many situation—such as partially enclosed or underground stations, tunnels or densely populated areas—where low emissions and moderate noise operation or no emissions and low noise operation are required, and these requirements cannot always be met by conventional diesel locomotives.

In addition, spillage of diesel fuel can cause environmental damage inside a tunnel or along the rail corridor. Fumes associated with the diesel fuel can also be environmentally harmful—particularly in confined areas such as tunnels. Spillage of hydraulic oil can also result in environmental damage inside the tunnel or along the rail corridor. This spillage can also affect the braking of other rolling stock and passenger trains, which can seriously compromise rail safety.

Maintenance vehicles may include many types of vehicles, including rail grinders. Railroad track rails are subject to wear by the passage of trains over the rails; and the head surfaces of railroad track rails which are in direct contact with the wheels and wheel flanges of rolling stock tend to wear unevenly. In particular, the cross sectional contour of the head can become misshapen, and depressions in the top surface of the railhead may develop such that the railhead presents a modulating, corrugated surface. Moreover, the railhead may develop burrs or otherwise lose its symmetrical profile. Such defects create undesirable vibration, particularly at high speeds, and also produce high noise levels. Maintenance of smooth running surfaces on railroad track rails is therefore important for reasons of: safety; riding comfort; protection of the track, track bed and rolling stock; and noise suppression.

Grinding machines have been developed for maintaining railroad track rails in smooth, properly-shaped condition. Such grinding machines generally comprise a plurality of rotatable grinding modules carried by a locomotive or the like in close proximity to the railhead surfaces of the track rail. The grinding modules include rotatable, abrasive grinding stones that can be lowered into a position flush with the rail surface to grind and restore the rail surface to a smooth, desired profile. In particular, on-track grinding trains carrying arrays of heavy grinding stones powered by high-horsepower motors have been used in such grinding operations. An example of such a rail-grinding car is disclosed in U.S. Pat. No. 4,583,327, in which there is described a rail-grinding car having vertical and horizontal grinding stone units. Horizontal grinding stones are generally annular with a flat, annular face being the grinding surface, whereas vertical grinding stones grind with an outer cylindrical surface of the stone. This grinding car embodies positioning control of an array of vertical grinding stones so that each stone properly engages the rail, and wherein the horizontal grinding stones are individually positionable to provide flexibility in grinding location and concentration on the rail heads.

Typical rail-grinding vehicles consist of two to four cars with a diesel power car driving a hydrostatic transmission on two or more trucks (bogies). The power car engine also drives a 575V AC generator which powers the electric grinding motor heads. The diesel-powered cars and hydrostatic transmissions, while providing an effective source of power for the grinding cars, generally pose operational problems and create various safety and environmental hazards, particularly when the grinding vehicle is operating in closed environments, such as tunnels.

It would, therefore, be beneficial to provide a completely battery-operated rail vehicle, such as, but not limited to, an aerial lift, track utility or grinder, for use where diesel fumes or smoke would endanger crews, and where external electricity supplies are not available or cannot be used safely. It would also be beneficial to provide battery-powered consists which can be charged directly from different sources, thereby eliminating the need to return to depots to refuel. In addition, it would also be beneficial to provide battery-powered locomotives and battery-powered maintenance cars which have independent systems, thereby eliminating the need to have 575V high-tension lines between cars, as is required with diesel-powered consists, thereby making coupling and un-coupling cars much easier for maintenance and transport.

### SUMMARY OF THE INVENTION

An object is to provide a battery-powered consist which is powered by electric current (i.e. electric cylinders, electric actuators), thereby eliminating the need for hydraulic cylinders and hydraulic oil, and eliminating the associated environmental and safety issues.

Another object is to provide a battery-powered consist which eliminates the build-up of carbon monoxide emissions associated with diesel-powered consists, thereby eliminating the possibility that the maintenance crew can be fatally poisoned.

Another object is to provide a consist in which the risk of a fire due to diesel fuel spillage or leak during operations or during track travel over live track is eliminated, as no diesel fuel is used.

Another object is to eliminate overheating of tunnels due to heat emissions from the exhaust of diesel fuel, which can cause failure of any or all components of the entire consist and which also can cause heat stress, de-hydration, heat-stroke, or cardiac arrest in the crew.

Another object is to provide a battery-powered consist which is more environmentally friendly, as spillage of diesel fuel and the harmful fumes associated therewith are eliminated.

Another object is to prevent spillage of hydraulic oil which can result in environmental damage inside the tunnel or along the rail corridor and which can affect the braking of other rolling stock and passenger trains, seriously compromising rail safety.

Another object is to provide a battery-powered vehicle consist which does not require refueling in a special bunker, thereby extending the range and endurance of the consist.

Another object is to provide a battery-powered consist than can charge directly from alternate sources of power.

Another object is to provide a consist in which the battery-powered propulsion cars and the battery-powered maintenance cars have independent systems, eliminating the requirement to have high-tension lines between the cars, thereby making coupling and un-coupling cars much easier for maintenance and transport.

One aspect is directed to a battery-powered rail consist having at least one battery-powered propulsion car and at least one rail car. The battery-powered propulsion car has at least one first battery thereon. The rail car, which is coupled to the at least one battery-powered propulsion car, has at least one second battery to supply power to work devices located on the rail car. The at least one first battery and the at least one second battery propel the propulsion car and power the work devices.

Another object is to provide a rail consist having at least one propulsion car having traction motors and at least one working car having working devices. At least one energy storage unit is provided on the consist to provide power to the traction motors and the working devices. The at least one energy storage unit provides sufficient power for work mode, travel speeds and curve characteristics of the consist. The use of the at least one energy storage unit provides safety, environmental and operational benefits.

Another object is to provide at least one energy storage unit which includes at least one first battery pack on the propulsion car and at least one second battery pack on the working car. The at least one first battery pack powers the traction motors and the at least one second battery pack powers the working devices.

Another object is to provide is a rail consist as recited in which at least one battery pack provides electrical power to a propulsion car bus. The propulsion car bus is configured to provide power to the traction motors which drive axles of the propulsion car and to a propulsion car auxiliary power inverter which operates other controls and equipment of the propulsion car.

Another object is to provide a rail consist in which the propulsion car bus is provided in electrical engagement with a working car bus. The propulsion car bus supplies power to the working car bus when excess power is generated by the at least one first battery pack.

Another object is to provide a rail consist in which the traction motors act as generators to return power to the propulsion car bus, whereby power flows back to the at least one first battery pack to charge the at least one first battery pack. Another object is to provide a rail consist in which regenerative brakes externally excite the traction motors to return power to the propulsion car bus.

Another object is to provide a rail consist in which a charging shoe or pantograph is provided to allow the energy storage units to be charged from the group consisting of a third rail, a catenary, or shore power.

Another object is to provide a rail consist in which a cab of the propulsion car is positioned at an end of the propulsion car and has controls provided therein to control the propulsion car and the working car.

Another object is to provide a rail consist in which the at least one second battery pack provides power to a working car auxiliary device through a second auxiliary power inverter.

Another object is to provide a rail consist in which the working car has grinders positioned thereon, the grinders being powered by the at least one energy storage unit to perform grinding operations on a rail.

Another object is to provide a rail consist in which an auxiliary power source is provided on the at least one propulsion car, the power source being configured to have low exhaust emissions. If an outside power connection is not present or feasible to recharge the at least one energy source unit, or if there is insufficient time to charge the at least one energy source unit to a fully charged condition when a demand is made for operations of the consist, the auxiliary power source is activated to charge the at least one energy source unit or to enable emergency travel of the consist.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side view of an embodiment of a battery-powered consist.

FIG. 2 is a side view of the cab portion of an alternative propulsion car or locomotive of the consist of FIG. 1.

FIG. 3 is a side view of an embodiment of a working car which may be used in the battery-powered consist.

FIG. 4 is a diagrammatic side view of an alternative embodiment of a working car which may be used in the battery-powered consist of a grinding car of the rail-grinding consist.

FIG. 5 is an exemplary flow chart of the power distribution system of the locomotive.

FIG. 6 is an exemplary flow chart of the power distribution system of the grinding car.

### DETAILED DESCRIPTION OF THE INVENTION

The invention is directed to a consist whose propulsive and auxiliary power is generated by one or more energy storage units, such as, for example, a large battery pack. While the exemplary embodiment described herein is directed to a rail-grinder consist, the claims are directed to any type of rail vehicle or consist, including, but not limited to, maintenance vehicles such as aerial lift vehicles, track utility vehicles and tampers.

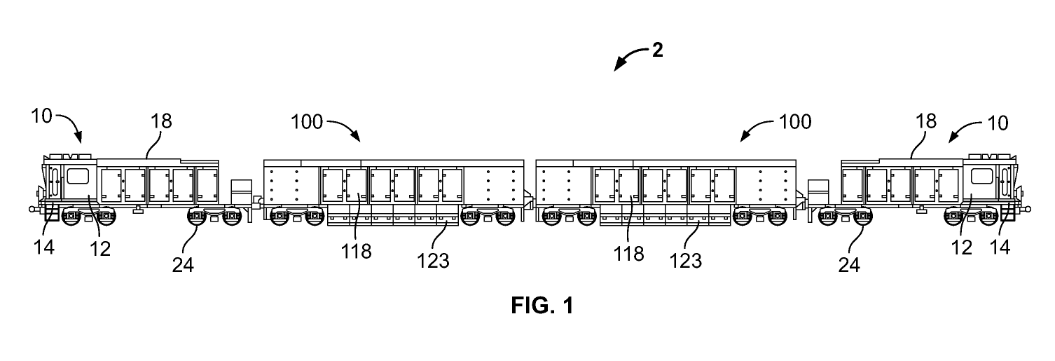

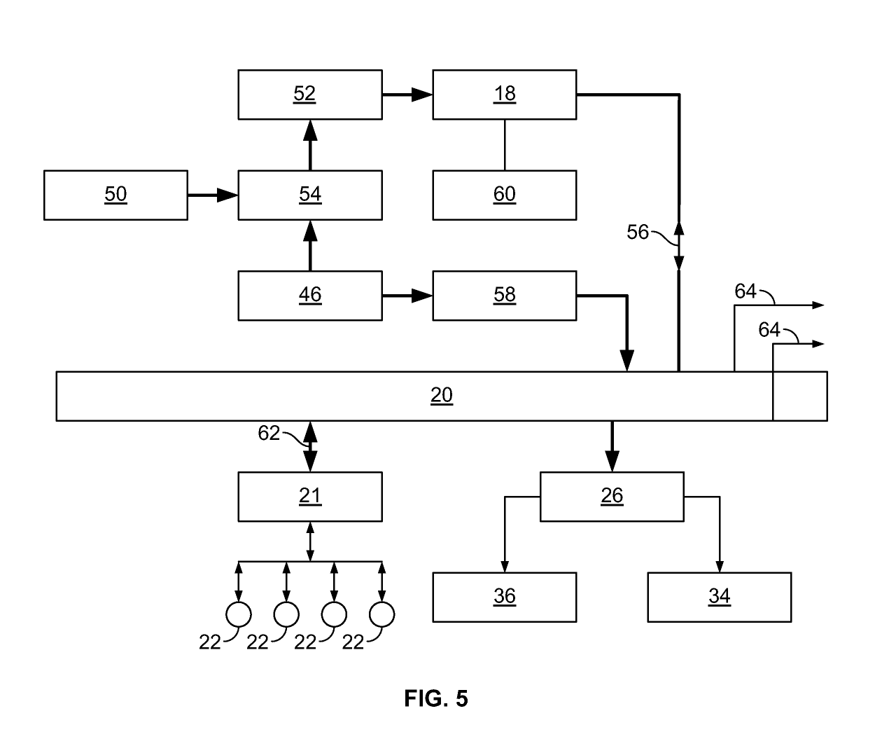

FIG. 1 is a schematic side view of the battery-powered rail consist 2 illustrating the functional relationships of the principal components of a consist. The exemplary embodiment depicts a rail-grinding consist having two electric power cars, propulsion cars or locomotives 10 and two working or grinding cars 100 positioned between the propulsion cars or locomotives 10. Other configurations, including varying numbers of locomotives and working cars and other types of working cars are possible without departing from the scope of the invention. Each locomotive 10 has a control cab 12 positioned proximate a respective end 14 thereof. The power for the locomotives 10 is provided by one or more batteries, battery packs or energy storage units 18 positioned on the locomotives 10. Referring to FIG. 5, the battery packs 18 provide DC electrical power to a DC bus 20. Power from the DC bus 20 can flow to or from the battery packs 18 or to a traction device 21 and a plurality of traction motors 22. Typically, the traction motors 22 each drive an axle and wheel pair 24. Alternatively, the DC bus 20 can provide power to the traction motors 22 simultaneously from both the battery packs 18 and an outside source, such as a third rail, as will be more fully discussed. The DC bus 20 may also transmit electrical power to an auxiliary power inverter 26, such as might be used to operate an air compressor 36 and other standard controls and equipment 34, such as the locomotive's lighting. If the traction motors 22 are AC motors, they receive AC power by means of inverters (not shown) connected to the DC bus 20. Alternately, if the traction motors 22 are DC motors, they receive DC power by means of chopper circuits (not shown) connected to the DC bus 20.

In one embodiment, when in braking mode, the traction motors 22 may act as generators to return power to the DC bus 20. The regenerative braking is typically accomplished by externally exciting the traction motors 22 that power the drive axles and converting them to electrical generators during a braking phase. Power can flow back to the battery packs 18. When a controller determines that the state-of-charge of the battery packs 18 reaches a predetermined upper limit, the excess energy from dynamic braking is transferred, by opening switch (not shown), to resistance bank or grids to be dissipated. While various braking systems may be used, the locomotive 10 shown has a conventional two-pipe braking system and a re-generation braking system.

The electric locomotive 10 may be a modified version of a Tomoe C838 locomotive engine, currently available in the market, which is manufactured by Tomoe Electric Manufacturing Company. However, the invention is not limited to the use of this particular configuration of locomotive engine. As discussed above, the electric locomotives 10 are provided with battery packs 18 which provide work mode, travel speeds to grade and curve characteristics. In one example of a representative locomotive 10, the propulsion care or locomotive battery packs' 18 capacity is sufficient for return track travel with the consist of approximately 24 km and a slow work cycle of up to four hours. However, the battery packs 18 may be sized and configured to provide the appropriate capacity required to perform the functions of the respective consist on which the battery packs 18 are located.

In the embodiment shown, the traction motors 22 are similar to the servo motor currently installed on the C838 locomotives. However, other alternatives, such as removal of the gear box and mounting of the motor directly on the axle, can be used without departing from the scope of the invention.

As the locomotive 10 has no diesel- or gas-powered engines, the propulsion and hauling of the consist is accomplished by power supplied by the battery packs 18 housed on the locomotive 10. Alternatively, in areas in which a third rail or catenary is present, the power may be drawn from the third rail or catenary. In such instances, the battery packs 18 of the locomotive 10 may be charged in both the parked and travel conditions from the third rails or catenaries. This can occur at any point on the track or siding. Alternatively, if no third rail or catenary is present, the battery packs 18 can be charged from a shore power connection in a depot, yard or maintenance workshop through the charging shoe 28 or pantograph (not shown) of the locomotive 10 or using other known methods.

As diesel and hydrostatic propulsion have been eliminated, the need for engines and engine controls which are used strictly for power is eliminated. The extra space in the propulsion car or locomotive cabs 12 can be used to house controls for the other cars in the consist, thereby allowing the locomotives 10 to double as control cars for the other operations. In the embodiment shown, the extra space is used to house grinder control, profile and corrugation systems, allowing the locomotives 10 to double as control cars in the grinding mode. By eliminating the engines and engine controls, manpower is reduced by dispensing with additional locomotive crews.

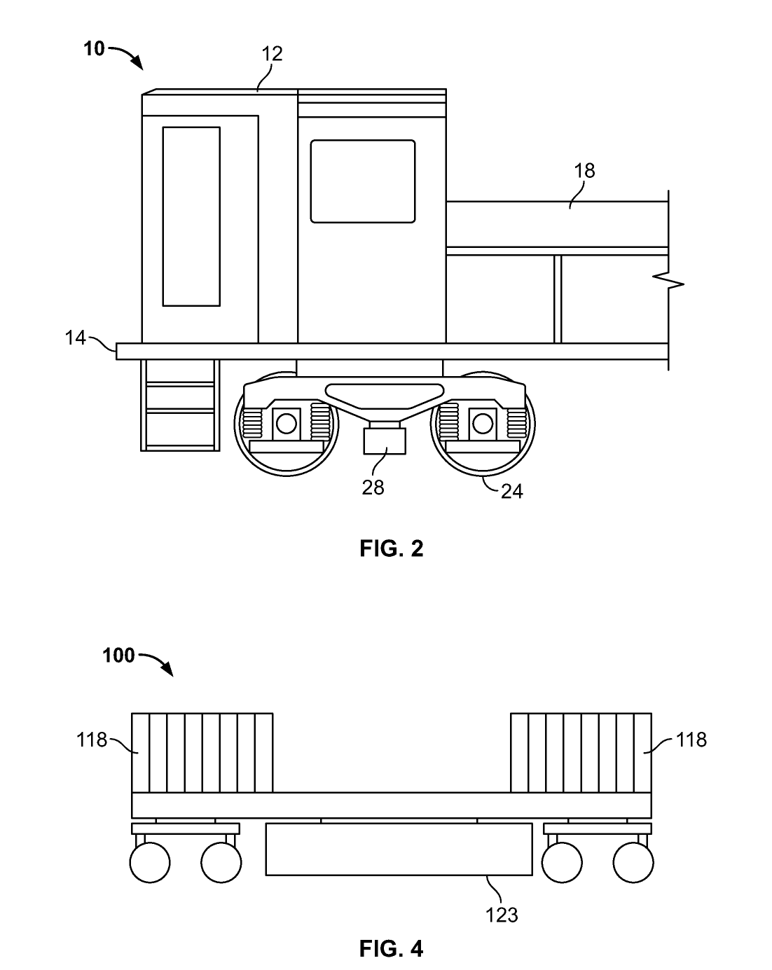

As stated, the locomotives are configured to allow both track travel and work mode operations. The control consoles and general cab 12 layout are similar to the existing grinder configurations with provision for control systems and terminals. The propel controls, battery status information screens, brake system gauges and controls used are known in the industry. In order to accommodate both track travel and work mode operations, the position of the cab 30 is moved toward a respective end 14, 16 to allow a better view of the pick-up and set-down points (FIGS. 1 and 2).

In the embodiment shown, a known inverter-driven three-cylinder two-stage air compressor 36 and twin dryer is used as the primary air system for the locomotive. As is shown in FIG. 5, the air compressor and twin dryer are powered by the DC bus 20 through the power inverter 26.

An auxiliary power source 46 may be provided on the locomotive 10. The power source 46 may be a turbine or mini-turbo generator or any other device having the power generation and low emissions characteristics required. The power source 46 is configured to be highly efficient (requiring a small fuel tank), have low exhaust emissions, have low heat emissions and have air bearings enabling the device to be environmentally clean with no lubricating oil spillage or drip. In the event that a third rail, catenary or access to a shore power connection is not present or feasible, or if there is insufficient time to charge the battery pack 18 to a fully charged condition when a demand is made for rail-grinding operations, the auxiliary power source 46 may be activated. The power source 46 is configured to i) charge the battery packs 18 while the locomotive 10 is stationary or en-route to the worksite, ii) enable the consist 2 to travel to the worksite even while the battery packs 18 have a low charge, iii) enable the consist to return to a stabling or temporary parking area after a full duty cycle with a low residual battery charge, iv) enable emergency travel at slow speed in case of a complete battery pack failure or accidental electrical discharge, and v) extend the range of the consist 2 with a long-distance surface travel to the worksite.

As is shown in the flowchart of FIG. 5, the commercial power source 50, which is the third rail, catenary, or shore power, may be electrically connected to the battery packs 18 through a charging system 52. Alternatively, if no commercial source is available, the auxiliary power source 46 is electrically connected to the charging system. A switch 54 is activated to place the proper power source in electrical engagement with the charging system. A battery management system 60 properly manages the charge of the battery packs 18. The battery packs 18, as indicated by arrow 56, can either deliver power to or draw power from the bus 20. In addition, the auxiliary power source 46 may deliver power directly to the bus 20 through the rectifier 58. The power is delivered from the bus 20 to the traction motors 22 to drive the locomotive 10. Alternatively, as shown by arrow 62, the brakes of the traction motors 22 may deliver power to the bus 20 when the brakes of the locomotive 10 are engaged. An inverter (not shown) may be provided between the bus 20 and the traction motors 22 if the motors are NC motors. The bus 20 delivers power to the air compressor and other controls of the locomotive 10 through the inverter. Excess power may be delivered by the bus 20 to the grinding cars as represented by arrows 64.

As the exemplary embodiment is directed to a rail grinder, it is helpful to first understand conventional rail procedures and equipment, such as rail-grinding procedures and equipment. The function of rail-grinding operations is to grind the surface of the railhead to remove imperfections and reform the shape of the railhead to reduce rolling friction and vibration. The reduction in friction and vibration results in reduced operating costs, increased passenger comfort, and higher operating speeds. While a particular rail grinder is described for illustrative purposes, the scope of the invention is not limited to the particular grinder shown. The battery system described below can be used for various types of equipment and consists.

In a typical grinding operation, a grinding car travels along rails which are to be resurfaced by multiple grinding units suspended from the underside of the grinding car. A typical rail-grinding car may carry two types of grinding units, vertical grinders and horizontal grinders. Each type of grinding device or unit includes a motor-driven grinding stone which is positioned against the railhead at an angle designed to grind the railhead to a desired surface configuration and/or smoothness.

Conventionally, the grinding stones are set at different angles to grind the flange of the railhead, and typically the gauge side, not only at a certain angle, but also to grind various facets onto the surface of the railhead in order to create a smooth transition between the various angles that are being ground. The goal is not to have any sharp edges on the rail flange of the railhead when the grinding process is completed. As grinding stones and the process of grinding railheads are well-known in the industry, further explanation of the grinding stones and the grinding process will not be provided.

Rail-grinding consists are normally comprised of two to four cars with a diesel-power car driving a hydrostatic transmission on two or more trucks (bogies). The power car engine also drives a 575V AC generator which powers the electric grinding motor heads of the grinding device. However, the diesel-power cars pose various environmental, safety and operational risks and problems.

Referring to FIG. 1, each grinding car 100 is powered by one or more batteries, battery packs or energy storage units 118 positioned on the grinding car 100. The battery packs 118 provide DC electrical power to a DC bus 120. Power from the DC bus 120 can flow to or from the battery packs 18 or to a plurality of grinding or working motors 122 which power multiple grinding units 123 suspended from the underside of the grinding car 100. A typical rail-grinding car 100 may carry two types of grinding units, vertical grinders and horizontal grinders. Each type of grinding unit includes a motor-driven grinding stone which is positioned against the railhead at an angle designed to grind the railhead to a desired surface configuration and/or smoothness. Alternatively, the DC bus 120 can provide power to the grinding motors 122 simultaneously from both the battery packs 118 and from the DC power bus 20 of the locomotive 10 which is electrically connected to the DC bus 120. The DC bus 120 may also transmit electrical power to an auxiliary power inverter 126, such as might be used to operate the grinding car's auxiliary air system 136 and other standard controls and equipment 134. If the grinding motors 122 are AC motors, they receive AC power by means of a main inverter (not shown) connected to the DC bus 120. Alternately, if the grinding motors 122 are DC motors, they receive DC power by means of chopper circuits (not shown) connected to the DC bus 120. The grinding cars 100 may have idler bogies similar to the bogies currently in use on an existing rail grinder.

In one example of a representative grinding car 100, the battery packs' 118 capacity for a standard 8 stone car rated for a grinding duration of 4 hours is rated at 600 Ah. In this example, two battery packs 118 of 188 cells each are provided on each grinding car 100, as shown in FIG. 4. Each cell is a 2V Type VCH 6A. Battery voltage should be approximately 700 to 750 V to be compatible with most Metro third rail voltage standards. Weight of the batteries required is approximately 13.8 MT. The necessary enclosures, supports and chargers are approximately 8 MT.

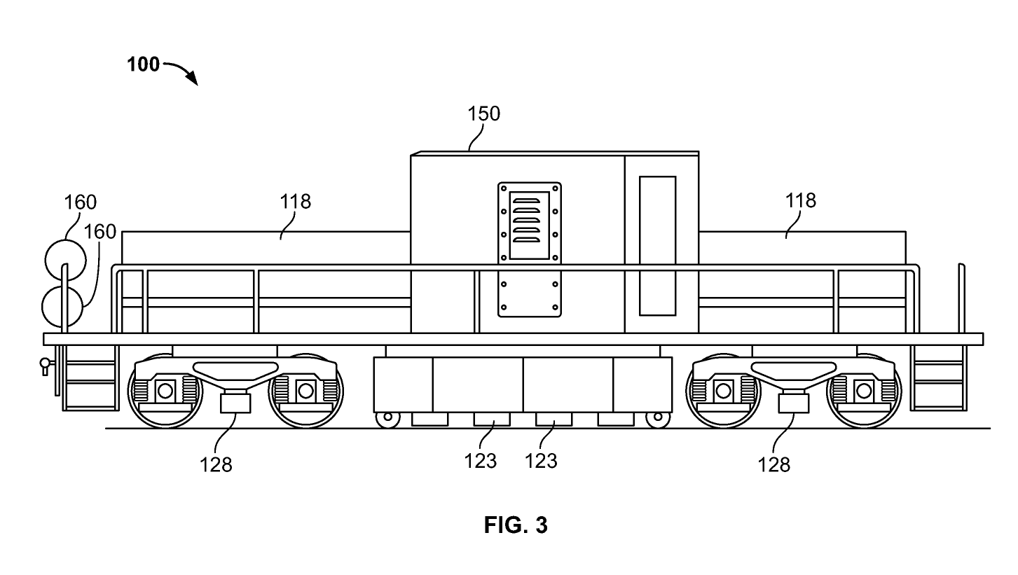

The grinding car battery packs 118 are used for powering the grinding motors on the grinding cars 100. The battery packs rated at approximately 3,600 Ah may be charged in both the parked and travel conditions from the third rails or catenaries (DC 750V). This can occur at any point on the track or siding. Alternatively, if no third rail or catenary is present, the battery packs 118 can be charged from a shore power connection (A/C 440V) in a depot, yard or maintenance workshop through the charging shoe 128 (FIG. 3) or pantograph (not shown) of the grinding car 100 or using other known methods.

The grinding motor head hydraulic feed, grind carriage lift, and angular positioning of the prior art grinding systems are replaced with servo-controlled electric linear actuators. Therefore, essentially no hydraulic systems are used for grinding work-head positioning and feed. The grinding motors 122 may include standard or servo-motors with either NC or DC versions rated at around 30 bhp at 3600 rpm. Cooling options on the grinding motors 122 include cold-compressed air cooling or standard liquid cooling. The cold-compressed air (Vortex cooling) would eliminate an expensive liquid system.

The locomotives 10 and grinding cars 100 may have independent, unconnected power systems. Alternately, the locomotives 10 and grinding cars 100 can have connected power systems through interconnect buses 20 and 120.

Dust-capture systems 150 are positioned on the grinding cars 100, as is illustrated in FIG. 3. These systems may be ESP or Cyclone-type dust-capture systems or blower-type dust collectors. Dust collectors used with the battery-powered consist 2 will be similar to those currently used with known equipment, except that dust collectors for the battery-powered consist 2 will generally be driven by DC motors.

In order to provide for appropriate water spray wash, each of the grinding cars 100 is provided with water tanks 160. In the embodiment shown, two water tanks 160 are positioned on each grinding car 110, with each water tank having a capacity of approximately 4500 liters.

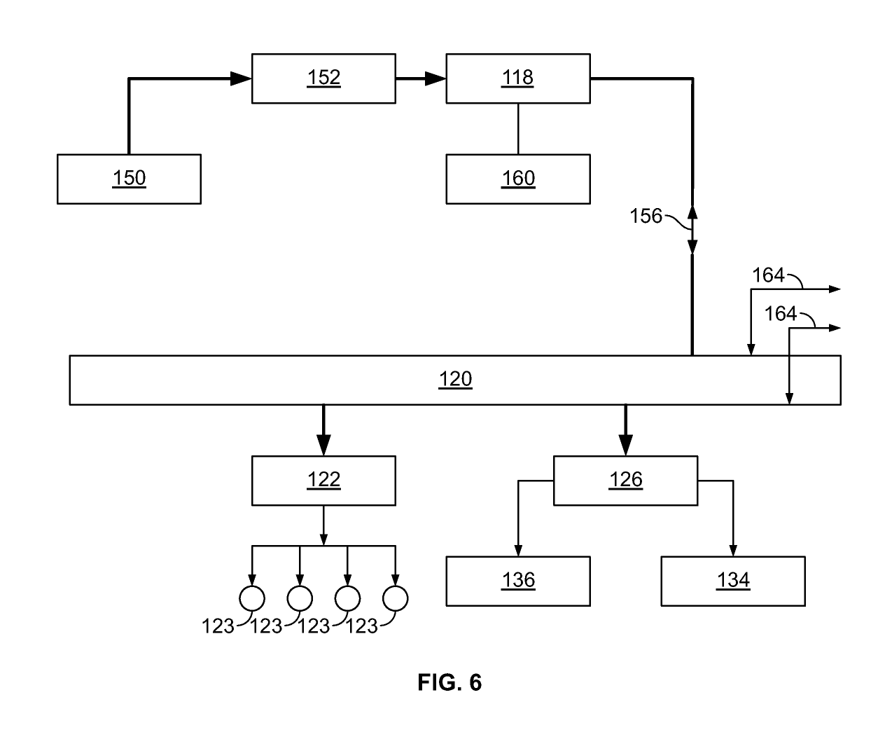

As is shown in the flowchart of FIG. 6, the commercial power source 150, which is the third rail, catenary, or shore power, may be electrically connected to the battery packs 118 through a charging system 152. A battery management system 160 properly manages the charge of the battery packs 118. The battery packs 118, as indicated by arrow 156, can either deliver power to or draw power from the bus 120. In addition, the bus 20 may deliver power to the bus 120, as indicated by arrows 164. The power is delivered from the bus 120 to the grinding motors 122 to drive the grinders of the grinding cars 100. The bus 120 also delivers power to the air compressor 136 and other controls 134 of the grinding car 100 through the inverter 126. If needed to operate the traction motors 22, power may be delivered by the bus 120 to the bus 20 of the locomotive 10 as represented by arrows 164.

The use of the battery-powered consist is advantageous for various safety reasons. The battery-powered consist eliminates the build-up of carbon monoxide emissions associated with diesel-powered consists, thereby eliminating the possibility that the grinding crew can be fatally poisoned if the cab pressurization and the gas detector device fail. In addition, the risk of a fire due to diesel fuel spillage or leak during operations or during track travel over live track is eliminated, as no diesel fuel is used.

Overheating of tunnels due to heat emissions from the exhaust of diesel fuel can cause failure of any or all components of the entire consist. Previous consists can cause external temperatures to rise in excess of 47 degrees Celsius, which can cause heat stress, de-hydration, heat-stroke, or cardiac arrest. With the use of battery-powered consists, this risk is minimized. In addition, as re-charge power is abundantly available everywhere in the system, the problems and risks associated with re-fueling underground (only possible in a special bunker) are also avoided.

The use of the battery-powered consist is advantageous for various environmental reasons. Spillage of diesel fuel can cause environmental damage inside a tunnel or along the rail corridor. This danger is eliminated with the battery-powered consist, as no diesel fuel is present. In addition, fumes associated with the diesel fuel can be environmentally harmful—particularly in confined areas such as tunnels. Spillage of hydraulic oil can also result in environmental damage inside the tunnel or along the rail corridor. This can also affect the braking of other rolling stock and passenger trains, which can seriously compromise rail safety. As the systems used in the battery-powered consist are powered by electric current (i.e. electric cylinders, electric actuators), the use of hydraulic cylinders, etc. is eliminated, thereby eliminating the need for hydraulic oil and eliminating the associated environmental and safety issues.

The use of the battery-powered consist is advantageous for various operational reasons. Refueling a diesel-powered rail-grinding consist or vehicle outside a special bunker or depot is a dangerous and difficult task. As the bunkers are located only in depots, the diesel-powered consists must return to the depot for refueling. This limits range and endurance of diesel consists, adding cost and inconvenience. As the battery-powered consists can charge directly from the third rail, the need to return to depots to refuel is eliminated. In addition, as the battery-powered locomotives and the battery-powered grinding cars have independent systems, there is no need to have a 575V high-tension line extend between the cars, as is required with diesel-powered consists. This makes coupling and un-coupling cars much easier for maintenance and transport. Also, the maintenance required for battery-powered consists or vehicles is greatly reduced, as the number of electrical circuits, hydraulic systems and generators is significantly reduced from that of the diesel-powered vehicles. A typical diesel-powered grinding vehicle has three different electrical circuits (575V, 24V, 250 V); two separate hydraulic systems (Transmission and Feed); and two separate generators (APU and Main) which must be maintained. In contrast, the battery-powered grinding vehicle has on electrical circuit which operates the grinding assembly.

While the invention has been described with reference to a preferred embodiment, it will be understood by those skilled in the art that various changes may be made and equivalents may be substituted for elements thereof without departing from the scope of the invention. As an example, the teaching of the present invention may be used for other types of rail equipment, other than just a rail-grinding vehicle In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A rail consist comprising:
at least one propulsion car having at least one traction motor;
at least one working car having at least one working device;
at least one energy storage unit provided on the consist, the at least one energy storage unit providing power to the at least one traction motor and the at least one working device, the at least one energy storage unit providing sufficient power for work mode, travel speeds and curve characteristics;
whereby the use of the at least one energy storage unit provides safety, environmental and operational benefits.

2. The rail consist as recited in claim 1, wherein the at least one energy storage unit includes at least one first battery pack on the at least one propulsion car and at least one second battery pack on the at least one working car, wherein the at least one first battery pack powers the at least one traction motor and the at least one second battery pack powers the at least one working device.

3. The rail consist as recited in claim 2, wherein the at least one battery pack provides electrical power to a propulsion car bus, the propulsion car bus configured to provide power to the at least one traction motor which drives axles of the at least one propulsion car and to a propulsion car auxiliary power inverter which operates other controls and equipment of the at least one propulsion car.

4. The rail consist as recited in claim 3, wherein the propulsion car bus is provided in electrical engagement with a working car bus, whereby the propulsion car bus supplies power to the working car bus when excess power is generated by the at least one first battery pack.

5. The rail consist as recited in claim 3, wherein the at least one traction motor acts as a generator to return power to the propulsion car bus, whereby power flows back to the at least one first battery pack to charge the at least one first battery pack.

6. The rail consist as recited in claim 1, wherein a charging shoe is provided to allow the at least one energy storage unit to be charged from the group consisting of a third rail, a catenary, or shore power.

7. The rail consist as recited in claim 1, wherein a cab of the at least one propulsion car is positioned at an end of the at least one propulsion car and has controls provided therein to control the at least one propulsion car and the at least one working car.

8. The rail consist as recited in claim 2, wherein the at least one second battery pack provides power to a working car auxiliary device through a second auxiliary power inverter.

9. The rail consist as recited in claim 1, wherein the at least one working device of the at least one working car are grinders positioned thereon, the grinders being powered by the energy storage unit to perform grinding operations on a rail.

10. The rail consist as recited in claim 4, wherein regenerative brakes externally excite the at least one traction motor to return power to the propulsion car bus, whereby power flows back to the at least one first battery pack to charge the at least one first battery pack.

11. The rail consist as recited in claim 1, wherein an auxiliary power source is provided on the at least one propulsion car, the auxiliary power source being configured to have low exhaust emissions, whereby if an outside power connection is not present or feasible to recharge the at least one energy source unit, or if there is insufficient time to charge the at least one energy source unit to a fully charged condition when a demand is made for operations of the consist, the auxiliary power source is activated to charge the at least one energy source unit or to enable emergency travel of the consist.

12. A rail consist comprising:
a propulsion car having a traction motor;
a working car having a working device;
an energy storage unit provided on the consist, the energy storage unit providing power to the traction motor and the working device, the energy storage unit providing sufficient power for work mode, travel speeds and curve characteristics of the consist;
an auxiliary power source provided on the propulsion car, the auxiliary power source being activated to provide power if an outside power connection is not present or feasible to recharge the energy source unit, or if there is insufficient time to charge the energy source unit to a fully charged condition when a demand is made for operations of the consist;
whereby the consist, including the energy storage unit and auxiliary power source, has low exhaust emissions.

13. The rail consist as recited in claim 12, wherein the energy storage unit includes a first battery pack on the propulsion car and a second battery pack on the working car, wherein the first battery pack powers the traction motor and the second battery pack powers the working device.

14. The rail consist as recited in claim 13, wherein the at least one battery pack provides electrical power to a propulsion car bus, the propulsion car bus configured to provide power to the traction motor which drives axles of the propulsion car and to a propulsion car auxiliary power inverter which operates other controls and equipment of the propulsion car.

15. The rail consist as recited in claim 14, wherein the propulsion car bus is provided in electrical engagement with a working car bus, whereby the propulsion car bus supplies power to the working car bus when excess power is generated by the at least one battery pack.

16. The rail consist as recited in claim 12, wherein a charging shoe is provided to allow the energy storage unit to be charged from the group consisting of a third rail, a catenary, or shore power.

17. The rail consist as recited in claim 13, wherein the at least second battery pack provides electrical power to a working car bus, the working car bus configured to provide power to the working devicer and to a working car auxiliary power inverter which operates other controls and equipment of the working car.

18. The rail consist as recited in claim 12, wherein the working device are grinders positioned on the working car, the grinders being powered by the energy storage unit to perform grinding operations on a rail.

19. A rail consist comprising:
a propulsion car having a traction motor;
a grinding car having a grinding device which power rail grinders;
an energy storage unit provided on the consist, the energy storage unit providing power to the traction motor and the grinding device, the energy storage unit providing sufficient power for work mode, travel speeds and curve characteristics of the consist;
an auxiliary power source provided on the propulsion car, the auxiliary power source being activated to provide power if an outside power connection is not present or feasible to recharge the energy source unit, or if there is insufficient time to charge the energy source unit to a fully charged condition when a demand is made for operations of the consist;
whereby the consist, including the energy storage unit and auxiliary power source, has low exhaust emissions.

20. The rail consist as recited in claim 19, wherein the energy storage unit has at least one first battery pack on the propulsion car and at least one second battery pack on the grinding car, the at least one first battery pack providing electrical power to a propulsion car bus, the propulsion car bus configured to provide power to the traction motor which drives axles of the propulsion car and to a propulsion car auxiliary power inverter which operates other controls and equipment of the propulsion car, the at least second battery pack providing electrical power to a grinding car bus, the grinding car bus configured to provide power to the grinding device and to a grinding car auxiliary power inverter which operates other controls and equipment of the grinding car.
